(19) United States
(12) Patent Application Publication
(10) Pub. No.: US 2022/0079726 A1
(43) Pub. Date: Mar. 17, 2022

(54) COVER WITH INTEGRATED FLOSS DISPENSER FOR TOOTHBRUSHES

(71) Applicant: Josekeitha White, Kenner, LA (US)

(72) Inventor: Josekeitha White, Kenner, LA (US)

(21) Appl. No.: 17/467,581

(22) Filed: Sep. 7, 2021

Related U.S. Application Data
(60) Provisional application No. 63/078,930, filed on Sep. 16, 2020.

(51) Int. Cl. A61C 15/04; A46B 9/04; A46B 17/04

(52) U.S. Cl. CPC A61C 15/043; A46B 9/04; A46B 2200/1066; A61C 15/041; A46B 17/04

(57) ABSTRACT

The present invention relates to an oral care device. The oral care device features a toothbrush head cover to protect the bristles of a toothbrush and an integrated dental floss storage and dispenser. The oral care device can also come with a paired toothbrush. The floss storage and dispenser allows the user to pull and cut a desired length of dental floss for flossing their teeth while the toothbrush head is securely placed in the toothbrush head cover. The dental floss can be replaced when required and the case can have manual or battery operated lids to access the toothbrush and the floss. The case protects the toothbrush bristles from dirt and debris while also providing dental floss to the user.

### CROSS-REFERENCE TO RELATED APPLICATION

The present application claims priority to, and the benefit of, U.S. Provisional Application No. 63/078,930, which was filed on Sep. 16, 2020 and is incorporated herein by reference in its entirety.

### FIELD OF THE INVENTION

The present invention relates generally to the field of dental hygiene products. More specifically, the present invention relates to a toothbrush cover comprising a compartment to store a toothbrush head, a compartment to store floss and a floss dispenser for dispensing the stored floss. The toothbrush cover ensures that the toothbrush bristles remain protected from unsanitary debris and prevents the transmission of germs, bacteria and other harmful pathogens via contact with the toothbrush bristles. Additionally, the toothbrush cover with integrated floss dispenser keeps both the toothbrush and floss in a single location, and makes both of the items readily available for convenient use. The toothbrush cover can be commercially available with toothbrushes of different colors, designs, patterns and bristle firmness as per the needs and requirements of the users. Accordingly, the present disclosure makes specific reference thereto. Nonetheless, it is to be appreciated that aspects of the present invention are also equally applicable to other like applications, devices and methods of manufacture.

### BACKGROUND OF THE INVENTION

By way of background, various dental products such as toothbrushes, floss and more are used daily by most people for their oral hygiene needs. Generally, toothbrushes are kept in a toothbrush holder/tumbler to allow users to easily organize their toothbrush in their bathrooms. Other dental hygiene products such as flossing devices can be kept in the same or at a separate location from the toothbrushes.

Generally, when toothbrushes and other oral care products are kept uncovered in the bathroom area, these oral care products may be susceptible to germs, bacteria and other debris. Once the bristles of the toothbrush or the floss thread of the flossing devices are exposed to germs, bacteria or other harmful pathogens, these oral care products can transmit germs and other pathogens to the users via direct contact with the mouth of the user, potentially causing various infectious diseases for the users.

Additionally, if people do not have a holder or organizer for storing their oral care products, then these people may be disappointed with how their bathroom area looks with toothbrushes, flossing devices, and other oral care hygiene products scattered around. The overall appearance of their bathroom can look unappealing.

Generally, people may find it difficult to manage multiple oral care products such as toothbrushes, flossing devices and other items and thus may be reluctant in using multiple oral care products to maintain oral hygiene. For example, people may avoid using floss devices to reduce their burden of handling multiple oral care products. Accordingly, people who don't use dental floss may lack proper oral care routines and may eventually suffer from different oral ailments.

Additionally, various kinds of flossing devices such as reusable and disposable flosses are available in the market. However, due to inconvenience in using disposable floss, people often end up using floss integrated into holders. However, the American Dental Association does not recommend using a floss strand more than once, as the used floss might fray, lose its effectiveness or may deposit bacteria in the mouth in case the used floss is not properly washed after every use. Thus, people are advised to use disposable floss to prevent the transmission of germs, bacteria and other harmful pathogens, and to prevent the spread of infectious diseases. However, buying multiple disposable floss heads can be expensive for the users and can be unmanageable as well.

Therefore, there exists a long felt need in the art for a device that allows users to safely keep their toothbrush and floss in the bathroom. There is also a long felt need in the art for a toothbrush cover that covers the toothbrush head and keeps the bristles protected from contracting any germs, viruses, bacteria or other harmful pathogens. Additionally, there is a long felt need in the art for a toothbrush cover that enables the users to easily manage multiple oral care products such as a toothbrush and dental floss, and prevents these oral care products from being scattered around to different locations in the bathroom. Moreover, there is a long felt need in the art for a covering device that allows users to keep a toothbrush and floss together. Further, there is a long felt need in the art for a device that keeps the floss easily accessible for the users and encourages floss use for the users in order to maintain good oral hygiene. Furthermore, there is a long felt need in the art for a storage device that allows easy storage of disposable floss and allows users to easily and quickly dispense a segment of floss thread as per the requirements. Finally, there is a long felt need in the art for a dental care products storage device that allows easy storage for a toothbrush and floss at a single place, ensures an appealing look in the bathroom and prevents the users from contracting any diseases through the use of uncovered oral care products such as toothbrushes or floss devices.

The subject matter disclosed and claimed herein, in one embodiment thereof, comprises an oral care device for storing a toothbrush in a toothbrush cover and having an integrated floss dispenser. More specifically, the oral care device comprises a toothbrush, a toothbrush cover and an integrated floss dispenser. The toothbrush cover has a toothbrush head compartment for receiving and storing the toothbrush head, and the integrated floss dispenser has a rotating bar for storing a roll of dental floss. Additionally, the integrated floss dispenser further comprises a locking bar and a floss cutter positioned on the top surface of the dispenser, wherein a user pulls a desired length of floss from the floss roll. which passes through the locking bar. The floss cutter acts to cut the desired length of floss for use by the user.

In this manner, the novel oral care device of the present invention accomplishes all of the forgoing objectives, and provides a relatively safe, easy and convenient solution for storing a toothbrush and floss together at a single location in a manageable manner, while ensuring a neat and clean look in the bathrooms. The oral care device of the present invention covers the bristles of the toothbrush and the floss thread as well, thereby protecting the bristles and/or floss thread from contracting any germs or other harmful pathogens, and therefore preventing the transmission of diseases. The device also ensures that oral care products such as toothbrushes and/or floss are readily available to users and therefore promotes the use of these oral care devices on a regular basis to maintain good oral hygiene.

### SUMMARY OF THE INVENTION

The following presents a simplified summary in order to provide a basic understanding of some aspects of the disclosed innovation. This summary is not an extensive overview, and it is not intended to identify key/critical elements or to delineate the scope thereof. Its sole purpose is to present some general concepts in a simplified form as a prelude to the more detailed description that is presented later.

The subject matter disclosed and claimed herein, in one embodiment thereof, comprises an oral care device. The oral care device is configured to provide users with a single device in which to store a toothbrush in a toothbrush cover along with an integrated floss dispenser. The oral care device comprises a toothbrush and a toothbrush cover with an integrated floss dispenser. Specifically, the toothbrush cover comprises a toothbrush head compartment for storing the toothbrush head and an integrated floss dispenser. The integrated floss dispenser comprises a rotating bar which stores a floss roll, a locking bar and a floss cutter on the top surface of the integrated floss dispenser. In use, a floss length from the floss roll passes through the locking bar and then is cut by the floss cutter to the desired length of floss needed by the user. Further, the toothbrush head compartment comprises a lid to access a cavity for storing the toothbrush head and the integrated floss dispenser comprises a hinged lid to access the rotating bar and a top lid to protect the locking bar and the floss cutter.

In a further embodiment of the present invention, a toothbrush cover with an integrated floss storage and dispenser is disclosed. The toothbrush cover has a toothbrush head compartment for receiving and storing a toothbrush head and a floss storage compartment for storing floss. The floss storage compartment comprises a spindle for storing floss, a floss locking pin for providing a guide path for a floss length from the spindle, and a floss cutter in the form of a sharp edge for cutting a desired length of the floss. The floss storage compartment is integrated with the toothbrush head compartment, and both have separate lids for accessing the corresponding internal cavities. The floss locking pin and the sharp edge are position on a top surface of the floss storage compartment and comprise a hinged top lid for protection.

In yet a further embodiment of the present invention, an oral hygiene case is disclosed. The oral hygiene case comprises a toothbrush head cover and a dental floss lid compartment. The toothbrush head cover is of a dimension in length and cross-section to secure a toothbrush head without damaging the bristles. Further, the toothbrush head cover has a hinged lid to access the inner cavity to store and retrieve the toothbrush head and an opening at the bottom to receive a handle of the toothbrush. The dental floss lid compartment has a dental floss spindle in the interior cavity which stores a roll of dental floss. In use, a length of floss is pulled from the dental floss spindle and is guided through a locking pin and a floss knife is used for cutting a desired length of the floss. The locking pin and the floss knife are positioned on the top surface of the dental floss lid compartment.

In a further embodiment of the present invention, a toothbrush cover with an integrated floss dispenser is disclosed. The floss dispenser comprises a floss holder for holding a portion of the floss for use in cleaning a user's teeth, wherein the floss dispenser comprises a floss guiding pin and a floss knife for allowing a user to cut a desired length of the floss without accessing the interior of the floss holder. A lid pivotally swings along an outside edge of the flossing dispenser to access the interior of the floss holder and a top lid pivotally swings along a top edge of the flossing dispenser to protect the floss guiding pin and a floss knife.

In a further embodiment of the present invention, the pivotal lids for accessing the toothbrush cover and the floss holder can be electronically operated using a tiny push button on exterior surface of the toothbrush cover. The oral care or hygiene case of the present invention is of durable construction and amenable to low-cost manufacturing. The case maintains protection over the bristles when stored in a bathroom, luggage container or other area. The case also provides dental floss for a complete oral care cycle.

To the accomplishment of the foregoing and related ends, certain illustrative aspects of the disclosed innovation are described herein in connection with the following description and the annexed drawings. These aspects are indicative, however, of but a few of the various ways in which the principles disclosed herein can be employed and are intended to include all such aspects and their equivalents. Other advantages and novel features will become apparent from the following detailed description when considered in conjunction with the drawings.

### BRIEF DESCRIPTION OF THE DRAWINGS

The description refers to provided drawings in which similar reference characters refer to similar parts throughout the different views, and in which:

FIG. 1 illustrates a perspective view of one potential embodiment of an oral care device of the present invention in accordance with the disclosed architecture;

FIG. 2 illustrates a perspective view of one potential embodiment of the toothbrush cover portion of the oral care device of the present invention in accordance with the disclosed architecture, wherein the cover is in an opened condition;

FIG. 3 illustrates a perspective view of one potential embodiment of the dental floss dispenser compartment of the oral care device of the present invention in accordance with the disclosed architecture, wherein the dental floss dispenser compartment is in an opened condition;

FIG. 4 illustrates a partial perspective view of one potential embodiment of the oral care product of the present invention in accordance with the disclosed architecture, wherein a toothbrush is being stored in a toothbrush compartment and a length of dental floss is being dispensed through the floss dispenser;

FIG. 5 illustrates a side cross-sectional and perspective view of one potential embodiment of the oral care device of the present invention in accordance with the disclosed architecture; and

FIG. 6 illustrates a perspective view of a user accessing a toothbrush from one potential embodiment of the oral care device of the present invention in accordance with the disclosed architecture.

### DETAILED DESCRIPTION OF THE PRESENT INVENTION

The innovation is now described with reference to the drawings, wherein like reference numerals are used to refer to like elements throughout. In the following description, for purposes of explanation, numerous specific details are set forth in order to provide a thorough understanding thereof. It may be evident, however, that the innovation can be practiced without these specific details. In other instances, well-known structures and devices are shown in block diagram form in order to facilitate a description thereof. Various embodiments are discussed hereinafter. It should be noted that the figures are described only to facilitate the description of the embodiments. They are not intended as an exhaustive description of the invention and do not limit the scope of the invention. Additionally, an illustrated embodiment need not have all the aspects or advantages shown. Thus, in other embodiments, any of the features described herein from different embodiments may be combined.

As noted above, there exists a long felt need in the art for a device that allows users to safely keep their toothbrush in the bathroom. There is also a long felt need in the art for a a toothbrush cover that covers the toothbrush head and keeps the bristles protected from contracting any germs, viruses, bacteria or other harmful pathogens. Additionally, there is a long felt need in the art for a toothbrush cover that enables the users to easily manage dental care products such as toothbrush and dental floss, and prevents these products from being scattered around at different locations in a bathroom. Moreover, there is a long felt need in the art for a covering device that allows users to keep their toothbrush and floss together. Further, there is a long felt need in the art for a device that keeps floss handy for the users and encourages floss use for the users in order to maintain good oral hygiene. Furthermore, there is a long felt need in the art for a storage device that allows easy storage of disposable floss and allows users to easily and quickly dispense floss thread as needed. Finally, there is a long felt need in the art for a dental care product storage device that allows easy storage of a toothbrush and floss at a single place, ensures an appealing look in the bathrooms and prevents the users from contracting any diseases through uncovered dental care products such as toothbrushes and/or floss devices.

The present invention, in one exemplary embodiment, is a novel toothbrush cover with an integrated floss storage and dispenser. The toothbrush cover has a toothbrush head compartment for receiving and storing a toothbrush head and a floss storage compartment having a spindle for storing floss, a floss locking pin for providing a guide path for a length of floss from the spindle, and a floss cutter in the form of a sharp edge for cutting a desired length of floss. The toothbrush head compartment and the floss storage compartment are integrated together and each have separate lids for accessing corresponding internal cavities. The locking pin and the floss cutter are position on a top surface of the floss storage compartment with a hinged top lid for protection.

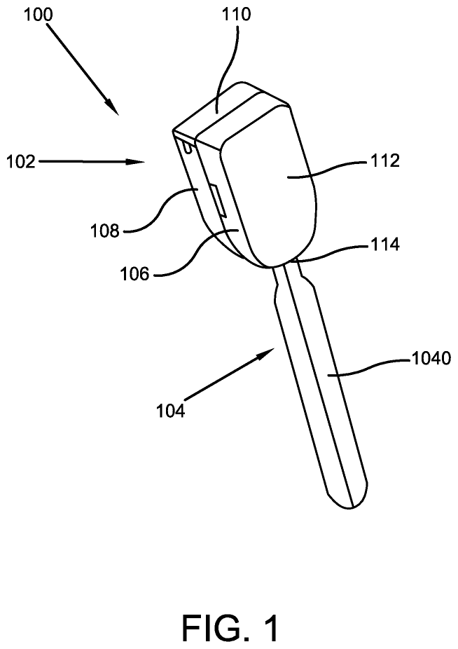

Referring initially to the drawings, FIG. 1 illustrates a perspective view of one potential embodiment of the oral care device of the present invention in accordance with the disclosed architecture. The oral care device 100 of the present invention comprises a toothbrush cover with integrated floss dispenser 102 and a toothbrush 104. The toothbrush cover with integrated floss dispenser 102 has two compartments that are symmetrically dimensioned. The first compartment, the toothbrush bristles compartment 106, is designed to store a head of the toothbrush 104. The toothbrush bristles compartment 106 has an opening 114 at the bottom for accommodating the handle 1040 of the toothbrush 104. The second compartment, the dental floss dispenser compartment 108 is integrated with the toothbrush bristles compartment 106 and dispenses the stored dental floss (not shown).

The toothbrush bristles compartment 106 has a lid 112 hinged along an outside edge allowing a user to access the internal cavity of the toothbrush bristles compartment 106 for storing and accessing the stored toothbrush 104. The dental floss dispenser compartment 108 has a top lid 110 which can be removed allowing the floss to be accessed for maintaining a complete oral hygiene routine.

The toothbrush cover with integrated floss dispenser 102 provides flexibility by allowing a toothbrush and dental floss to be stored in a single device. Electric toothbrushes can also be easily stored in the cover 102. The toothbrush cover with integrated floss dispenser 102 eliminates the need for a separate storage device for dental floss and also reduces packing size for transport and sales, and minimizes contact with contaminating materials.

The toothbrush bristles compartment 106 and the floss dispenser compartment 108 are integrated together and each have corresponding lids to access their respective internal cavities. The toothbrush bristles compartment 106 can also comprise an internal mesh structure (not shown) to provide protection to the bristles of the toothbrush 104. The toothbrush bristles compartment 106 and dental floss dispenser compartment 108 also comprise sidewalls extending around the perimeter of the toothbrush cover with integrated floss dispenser 102, these sidewalls are covered by the corresponding lids to form the cavities therein. It should be noted that a user can access the toothbrush bristles compartment 106 and the floss dispenser compartment 108 separately and the compartments 106 and 108 are independent of each other in use.

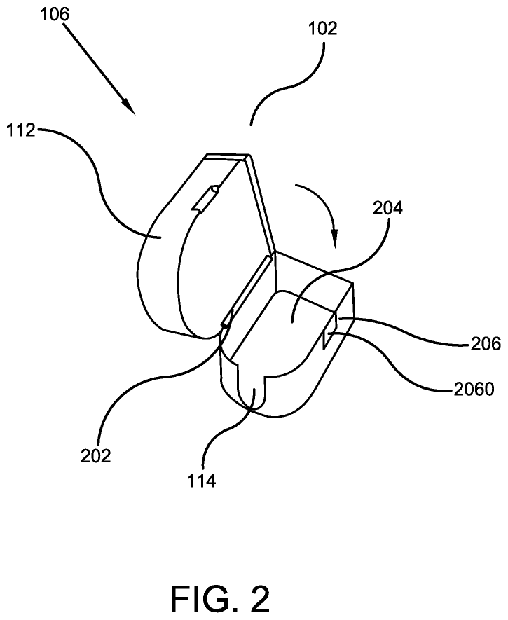

FIG. 2 illustrates a perspective view of the toothbrush bristles compartment 106 of the toothbrush cover with integrated floss dispenser 102 in accordance with the disclosed architecture. The toothbrush bristles compartment 106 is configured for securely storing a toothbrush head. The compartment 106 has a cavity 204 for storing the toothbrush head. The cavity 204 is formed by the fixed body 206 and the hinged lid 112 therein. The hinged lid 112 is hinged along the outside edge 202 allowing pivotal movement of the hinged lid 112 relative to the fixed body 206. Typically, the hinges are plastic and made of the same material as the hinged lid 112 and fixed body 206, but can be made of any suitable material as is known in the art.

To accommodate the handle of a toothbrush, the fixed body 206 has an opening 114 dimensioned as per the size and shape of a conventional toothbrush handle. To store a toothbrush, a user opens the hinged lid 112 allowing a user to access the cavity 204 and the toothbrush head is stored with the handle placed through the opening 114. Once the toothbrush head is placed in the cavity 204, the lid 112 is fastened to the fixed body 206. A fastener 2060 such as a mechanical or magnetic fastener, or any other suitable fastener as is known in the art, can be used for locking the lid 112 with the fixed body 206.

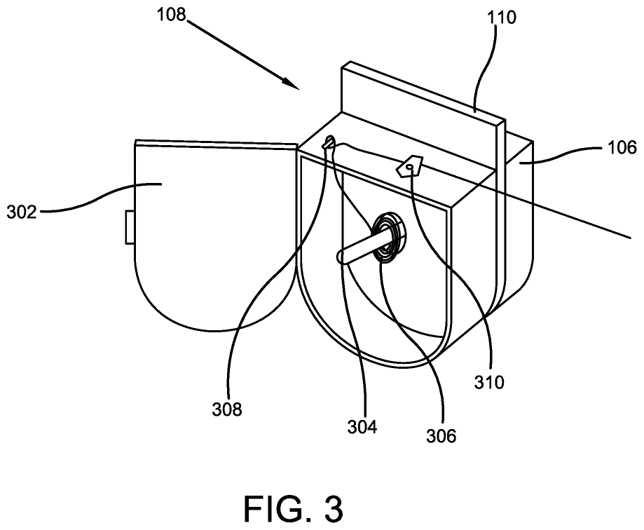

FIG. 3 illustrates an internal view of the dental floss dispenser compartment 108 in accordance with the disclosed architecture. As illustrated, the dental floss dispenser compartment 108 is integrated with the toothbrush head compartment 106. The dental floss compartment 108 has a hinged lid 302 allowing a user to access the stored floss 306 spindled around a rotating bar 304. A user can easily place a roll of floss around the rotating bar 304 after opening the hinged lid 302 when the floss is finished.

The floss length is secured by a holder pin 308 through which the floss length passes through a floss cutter 310. The floss holder pin 308 and the floss cutter 310 are placed on the top surface of the dental floss compartment 108 and are protected by the top lid 110. The top lid 110 is hinged and can be pivotally opened to access the floss holder pin 308 and the floss cutter 310. The floss cutter 310 comprises a sharp edge for cutting a desired length of the floss 306. When the user pulls the floss length to a desired length of the floss 306, the rotating bar 304 rotates allowing smooth removal of the floss 306. After use, the top lid 110 can be fastened to secure the floss holder pin 308 and the floss cutter 310. Both the top lid 110 and the hinged lid 302 can be fastened using a mechanical or magnetic fastener, or any other suitable fastener known in the art.

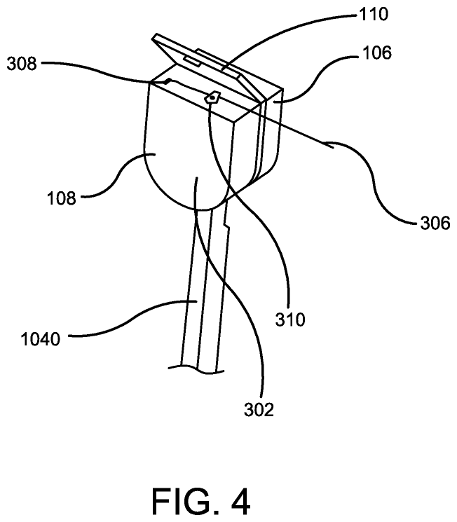

FIG. 4 illustrates a perspective view of the toothbrush stored in the toothbrush bristles compartment 106 and a floss length dispensed through the floss dispenser compartment 108 in accordance with the disclosed architecture. To access the floss length 306, a user can remove the top lid 110 to pull the floss length 306 and cut the length via the floss cutter 310. The floss length 306 is secured for cutting by the floss holder pin 308. It should be noted that the floss length 306 can be accessed even while the toothbrush head compartment 106 stores the toothbrush. The floss dispenser compartment 108 and the toothbrush bristles compartment 106 can be independently accessed as per the preferences of a user. The toothbrush cover 102 can be wall mounted. The hinged lid 302 of the floss dispenser compartment 108 can have an adhesive or other securing means on the exterior surface allowing the toothbrush cover 102 to attach to a wall.

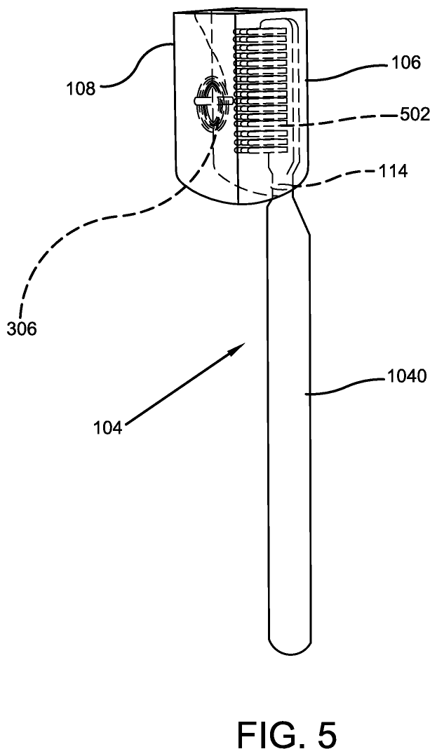

FIG. 5 illustrates a side view of the oral care device of the present invention in accordance with the disclosed architecture. As stated earlier, the oral care device 100 comprises a toothbrush 104 and a toothbrush cover 102. The toothbrush head comprising bristles 502 is stored in the toothbrush bristles compartment 106 with the handle 1040 passing through an opening 114 at the bottom. The toothbrush bristles compartment 106 provides protection over the bristles 502 when the toothbrush 104 is stored in a bathroom, luggage container, or other area. Both manual and electric toothbrushes 104 can be stored in the toothbrush bristles compartment 106. The commercially available toothbrush 104 can be available in several colors, designs, patterns styles, and/or with different brush firmness.

The floss dispenser compartment 108 stores floss 306 that can be easily dispensed through the top surface of the floss dispenser compartment 108. It should be noted that the cover 102 including the toothbrush bristles compartment 106 and the floss dispenser compartment 108 can be commercially available with any type of toothbrush 104 as a safety accessory.

In one embodiment of the present invention, the lids of both the toothbrush bristles compartment 106 and the floss dispenser compartment 108 can be operated via a tiny control button present on an exterior surface of the cover 102. This is advantageous for people with limited physical movement.

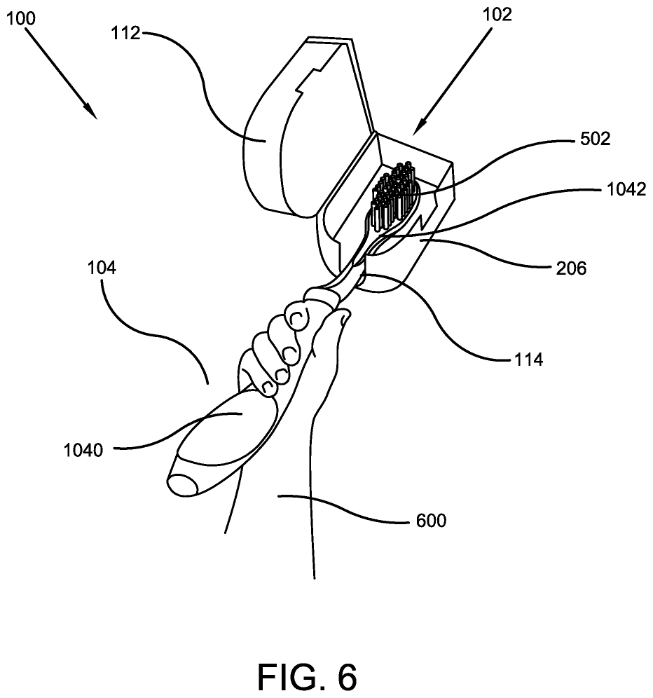

FIG. 6 illustrates a perspective view of a user accessing a toothbrush from the oral care device 100 of the present invention in accordance with the disclosed architecture. As shown, to store or to access toothbrush 104, the toothbrush head 1042 is stored in the fixed body 206 such that bristles 502 can face the hinged lid 112 or the bristles 502 also can face the rear wall of the fixed body 206. The handle 1040 is held by a user's hand 600 allowing the user to easily access or store the toothbrush 104. The bristles 502 when stored inside the toothbrush bristles compartment 106 ensure that the bristles 502 are protected from unsanitary debris.

The oral care device 100 comes with different types of brushes having different bristle firmness, thereby allowing the user to choose the specific device 100 including the brush 104 and the cover 102 as per their wants and/or needs.

The present invention provides a dental floss dispensing compartment 108 that facilitates the replacement of the dental floss spindle/rotating bar 304. The rotating bar 304 rotates when a floss length is pulled by a user, which allows a user to pull a desired length of floss. The holder pin 308 allows a user to guide the floss length from the interior of the floss dispenser compartment 108 through the holder pin 308 and then to the floss cutter 310 which cuts the floss length for easy access by the user.

The toothbrush cover with integrated floss dispenser 102 can be made of injection-molded ABS plastic, but could also be manufactured of any other suitable plastic material such as polystrene, polycarbonate, polyproplene, or a metal, or other suitable material as is known in the art.

Certain terms are used throughout the following description and claims to refer to particular features or components. As one skilled in the art will appreciate, different persons may refer to the same feature or component by different names. This document does not intend to distinguish between components or features that differ in name but not structure or function. As used herein “oral care device”, “oral hygiene case”, “Toothbrush cover with toothbrush” and “device”, are interchangeable and refer to the oral care device 100 of the present invention.

Notwithstanding the forgoing, the oral care device 100 of the present invention can be of any suitable size and configuration as is known in the art without affecting the overall concept of the invention, provided that it accomplishes the above stated objectives. One of ordinary skill in the art will appreciate that the size, configuration, and material of the oral care device 100 as shown in the FIGS. are for illustrative purposes only, and that many other sizes and shapes of the oral care device 100 are well within the scope of the present disclosure. Although the dimensions of the oral care device 100 are important design parameters for user convenience, the oral care device 100 may be of any size that ensures optimal performance during use and/or that suits the user's needs and/or preferences.

Various modifications and additions can be made to the exemplary embodiments discussed without departing from the scope of the present invention. While the embodiments described above refer to particular features, the scope of this invention also includes embodiments having different combinations of features and embodiments that do not include all of the described features. Accordingly, the scope of the present invention is intended to embrace all such alternatives, modifications, and variations as fall within the scope of the claims, together with all equivalents thereof.

What has been described above includes examples of the claimed subject matter. It is, of course, not possible to describe every conceivable combination of components or methodologies for purposes of describing the claimed subject matter, but one of ordinary skill in the art may recognize that many further combinations and permutations of the claimed subject matter are possible. Accordingly, the claimed subject matter is intended to embrace all such alterations, modifications and variations that fall within the spirit and scope of the appended claims. Furthermore, to the extent that the term “includes” is used in either the detailed description or the claims, such term is intended to be inclusive in a manner similar to the term “comprising” as “comprising” is interpreted when employed as a transitional word in a claim.

What is claimed is:

1. An oral care device for protecting a toothbrush head and dispensing a floss, the oral care device comprising:
a toothbrush cover with integrated floss dispenser comprising a first compartment for storing the toothbrush head and a second compartment for dispensing the floss; and
a toothbrush comprising the toothbrush head and a handle.

2. The oral care device of claim 1, wherein the first compartment is a toothbrush bristles compartment which comprises an internal cavity for storing the toothbrush head.

3. The oral care device of claim 2, wherein the toothbrush bristles compartment comprises an opening at a first end for accommodating the handle of the toothbrush.

4. The oral care device of claim 3, wherein the toothbrush bristles compartment comprises a hinged lid for accessing the internal cavity of the toothbrush bristles compartment.

5. The oral care device of claim 2, wherein the second compartment is the dental floss dispenser compartment which comprises an internal cavity for storing the floss.

6. The oral care device of claim 5, wherein the dental floss dispenser compartment comprises a top lid which is opened when removing the floss from the oral care device.

7. The oral care device of claim 6, wherein the dental floss dispenser compartment comprises a hinged lid for accessing the internal cavity.

8. The oral care device of claim 7, wherein the dental floss dispenser compartment comprises a rotating bar within the internal cavity for storing a roll of floss.

9. The oral care device of claim 8, wherein the dental floss dispenser compartment comprises a floss holder pin for securing a strand of floss and a floss cutter for cutting a desired length of floss.

10. The oral care device of claim 9, wherein the floss holder pin and the floss cutter are positioned on a top surface of the dental floss compartment and protected by the top lid.

11. The oral care device of claim 1, wherein the first and second compartments are integrated together as a single unit.

12. The oral care device of claim 1, wherein the first and second compartments are independent of each other in use.

13. An oral care device for protecting a toothbrush head and dispensing a floss, the oral care device comprising:
a toothbrush cover with integrated floss dispenser comprising a toothbrush bristles compartment and a dental floss dispenser compartment, wherein each of the toothbrush bristles compartment and the dental floss dispenser compartment comprises an interior cavity secured with a hinged lid; and
a toothbrush comprising a toothbrush head and handle.

14. The oral care device of claim 13, wherein each hinged lid comprises a mechanical fastener for securing the hinged lid to the toothbrush cover.

15. The oral care device of claim 14, wherein the toothbrush bristles compartment comprises an opening at one end for accommodating the handle of the toothbrush.

16. The oral care device of claim 15, wherein the dental floss dispenser compartment comprises a top lid which is opened when removing the floss.

17. The oral care device of claim 16, wherein the dental floss dispenser compartment comprises a rotating bar within the internal cavity for storing a roll of floss.

18. The oral care device of claim 17, wherein the dental floss dispenser compartment comprises a floss holder pin for securing a strand of floss and a floss cutter for cutting a desired length of floss.

19. The oral care device of claim 18, wherein the floss holder pin and the floss cutter are positioned on a top surface of the dental floss compartment and protected by the top lid.

20. An oral care device for protecting a toothbrush head and dispensing a floss, the oral care device comprising:
a toothbrush cover with integrated floss dispenser comprising a toothbrush bristles compartment and a dental floss dispenser compartment; and
a toothbrush comprising a toothbrush head and handle; and
wherein both the toothbrush bristles compartment and the dental floss dispenser compartment each comprise an interior cavity secured with a hinged lid and mechanical fastener positioned on the hinged lid; and
wherein the dental floss dispenser compartment comprises a rotating bar within the internal cavity for storing a roll of floss, a floss holder pin for securing a strand of floss, and a floss cutter for cutting a desired length of floss.
